(19) United States
(12) Patent Application Publication
(10) Pub. No.: US 2004/0135332 A1
(43) Pub. Date: Jul. 15, 2004

(54) E-Z op 3 wheel-wheel barrow

(76) Inventor: Jimmy Dimitros Babacos, Colton, CA (US)

Correspondence Address: JIMMY DIMITROS BABACOS, 1012 N Sunset Circle, Rialto, CA, 92376, US

(21) Appl. No.: 10/198,226

(22) Filed: Jan. 10, 2003

(51) Int. Cl. B62B 1/00

(52) U.S. Cl. 280/47.31

(57) ABSTRACT

E-z Op Wheel Barrow With Three Wheels

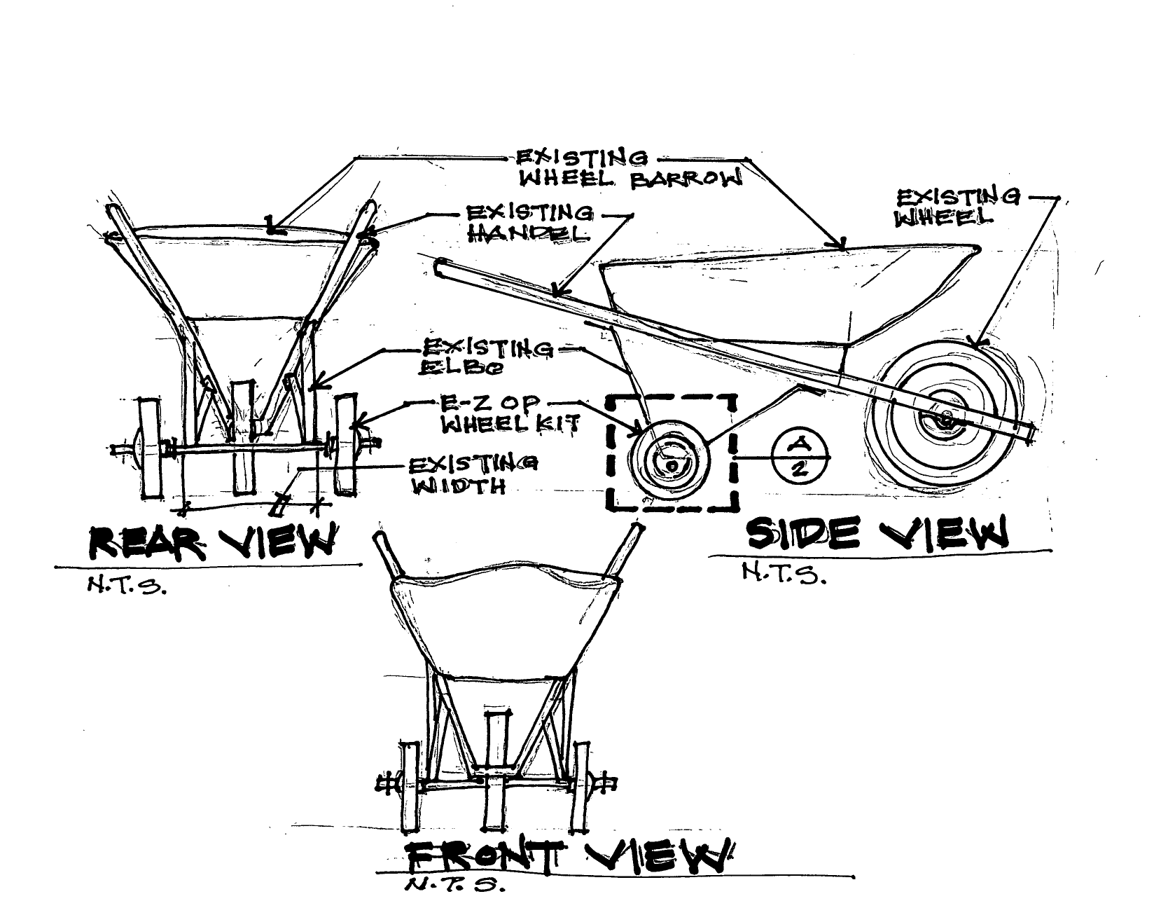

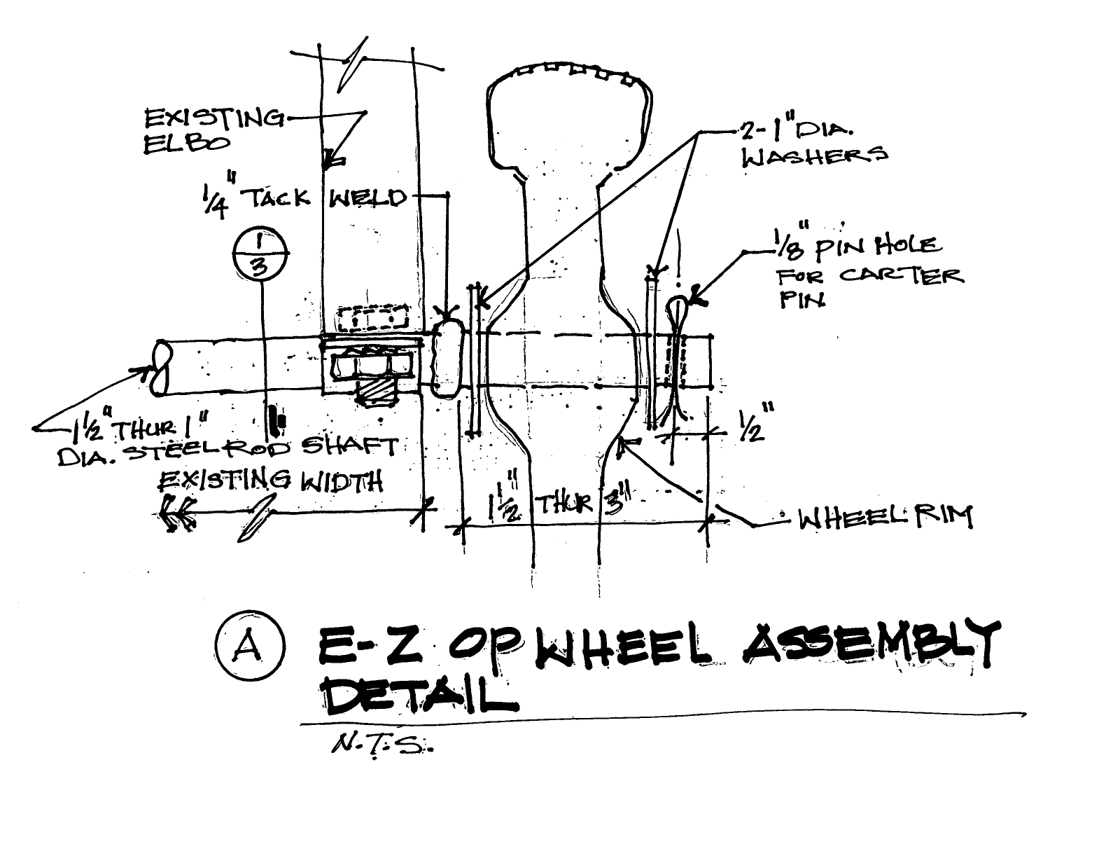

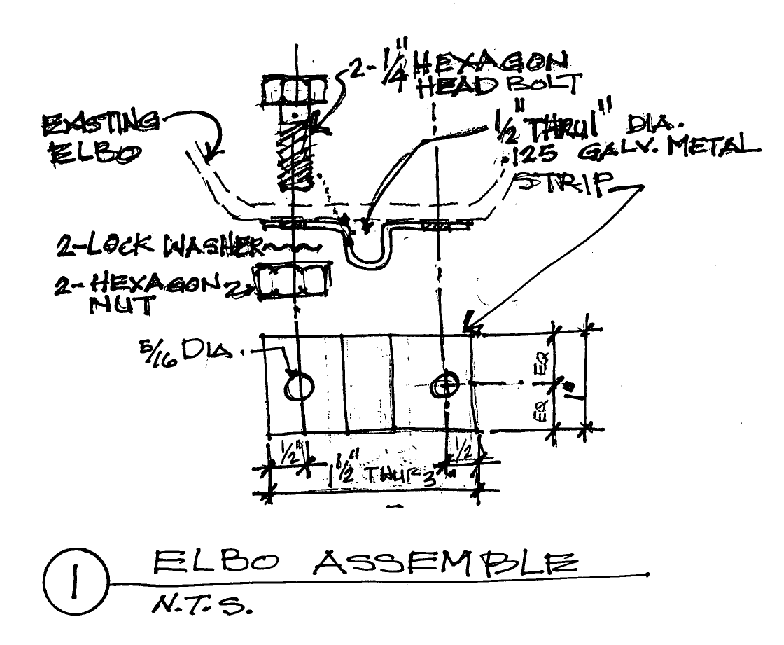

### SPACIFICATIONS

The E-Z OP 3 wheel kit can work on any exsisting wheel barrow with or it is made of metal or plastic or any kind of matirial, what is a wheel barrow in good condition with one front wheel and two metal or palstic elbow in good working condition.

We take the metal or plastic elbow and add two round wheels with the E-Z OP wheel kit assembley. Attach 2-⅛^{th} calvenized metal strip, linch wide by 1 ½ to 3 inches long in length at base or metal rodshaft ½ to 1 inche in diameter on the base of each elbow fastend with 2-1 ¼ Hexagon head bold; 2 lock whasers, and 2 hexagon nuts. Over A 24″ X ½ to 1″ diameter steel rod-saft with A ⅛ pin hole on both ends ½ an inch from the end with a caren pin 1″ to ½ inch long in each hole, to secure wheel to the steel rodsaft to prevet wheels from coming off and A 1Δ Dia washers to buttenup Against A ¼ tack welded nott all around steel rodsaft @ 1 ½ to 3″ from the end of rod to prevent wheels from sliping on the inside.

1. The E-Z OP 3 wheel kit on wheel barrow will make any existing wheel barrow operate with base and litter effort. Easy to lift and opperate with less efforton your back, can go up and down landing down without tilting over. Can manualable over all treads and reason of any height or lenght. Can go over stop and landing with very little effort.

2. You can overload wheel barrow with any shap or length of matirial and can still opperate the wheel barrow by pushing. Not liftting ground The wheel manulable over any surface.

3. That is grass gravel pament conctreat derect sun plus it is easy to store.

4. You can drive the wheel barrow on eatheir one wheel, two wheels, or three wheels.

5. You can turn left or right by one wheel or two wheels by pushing the hand bars to the ground.
